(19) United States
(12) Patent Application Publication
(10) Pub. No.: US 2025/0214215 A1
(43) Pub. Date: Jul. 3, 2025

(54) HAMMERING TOOL WITH DAMPING STRUCTURE

(71) Applicant: Easy Strike Co., Ltd., Taipei City (TW)

(72) Inventor: YUNG-SHOU CHEN, Taipei City (TW)

(21) Appl. No.: 18/966,915

(22) Filed: Dec. 3, 2024

Related U.S. Application Data
(60) Provisional application No. 63/616,348, filed on Dec. 29, 2023.

(51) Int. Cl. B25D 1/12; B25D 1/04

(52) U.S. Cl. CPC B25D 1/12; B25D 1/04

(57) ABSTRACT

A hammering tool with damping structure includes a strike member, a handle, a spacing member, and a handle sleeve. The handle is connected with the strike member and has a shock damping structure disposed on one side thereof, such that the handle has a non-smooth outer periphery. The spacing member is detachably connected with the handle corresponding to the shock damping structure, with a gap formed between the spacing member and the shock damping structure. The handle sleeve is mounted around the handle and the spacing member, and the handle sleeve is fittingly attached to the spacing member.

### CROSS REFERENCE TO RELATED APPLICATIONS

This application claims priority of U.S. Provisional Application No. 63/616,348 filed on Dec. 29, 2023 under 35 U.S.C. § 119(e), the entire contents of which are hereby incorporated by reference.

### BACKGROUND OF THE APPLICATION

### 1. Field of the Application

The present application relates to hammering tools, and more particularly, to a hammering tool with damping structure capable of reducing vibration during usage.

### 2. Description of the Related Art

A conventional hammer usually comprises a metal striking head and a handle. The striking head is the part used to hit an object, and the handle is the part used for gripping and controlling the hammer.

When using the conventional hammer, impact of the striking head hitting an object generates vibration, which is then transmitted to the handle and subsequently affects the user. Such effect occurs because the conventional hammer handle lacks effective shock reducing structures, resulting in vibrations being directly transmitted to the user's hand, so as to cause fatigue and discomfort, thereby limiting the working efficiency during prolonged operation, and possibly leading to discomfort or pain in the hand after a long-term usage.

### SUMMARY OF THE APPLICATION

To improve the issues above, the present application discloses a hammering tool with damping structure. By use of the gap serving as an air chamber between the shock damping structure and the spacing member, the vibration of the handle is reduced, thereby achieving a shock reducing effect.

For achieving the aforementioned objectives, the present application provides a hammering tool with damping structure, comprising:
a strike member;
a handle connected with the strike member, the handle comprising a shock damping structure disposed on one side thereof, such that the handle has a non-smooth outer periphery;
a spacing member detachably connected with the handle corresponding to the shock damping structure, with a gap formed between the spacing member and the shock damping structure; and
a handle sleeve mounted around the handle and the spacing member, the handle sleeve and the spacing member being fittingly attached.

With such configuration, when striking an object with the strike member, the shock generated on the handle is mitigated through the gap, which serves as an air chamber between the shock damping structure and the spacing member, wherein the air in the gap produces an elastic force to damp the shock caused by the striking impact, thereby achieving the vibration reduction effect. Thus, the present application improves the issue of the conventional hammer unable to reduce the shock.

### BRIEF DESCRIPTION OF THE DRAWINGS

FIG. 1 is a perspective view of the present application.

FIG. 2 is an exploded view of the present application.

FIG. 3 is a cross-sectional view taken along line A-A in FIG. 1.

FIG. 4 is a cross-sectional view of the first embodiment taken along line B-B in FIG. 1.

FIG. 5 is a sectional view of the second embodiment of the present application.

FIG. 6 is a sectional view of the third embodiment of the present application.

FIG. 7 is a sectional view of the fourth embodiment of the present application.

FIG. 8 is a perspective view of the present application, illustrating the strike member and the handle being integrally formed.

FIG. 9 is a cross-sectional view of the fifth embodiment taken along line C-C in FIG. 8.

FIG. 10 is a sectional view of the sixth embodiment of the present application.

### DETAILED DESCRIPTION OF THE APPLICATION

The aforementioned and further advantages and features of the present application will be understood by reference to the description of the preferred embodiment in conjunction with the accompanying drawings where the components are illustrated based on a proportion for explanation but not subject to the actual component proportion.

The directional terms of, for example, “up”, “down”, “front”, “rear”, “left”, “right”, “inner”, “outer”, and “side” are only used herein for illustrating the relative directions shown in the drawings. Therefore, the directional terms are applied for the purpose of illustration and understanding of the present application, instead of limiting the present application.

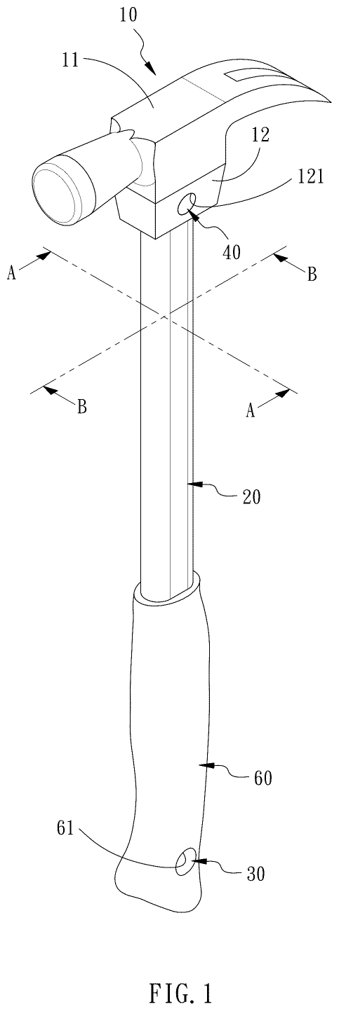

Referring to FIG. 1 to FIG. 10, the present application provides a hammering tool with damping structure, comprising a strike member 10, a handle 20, a spacing member 50, and a handle sleeve 60.

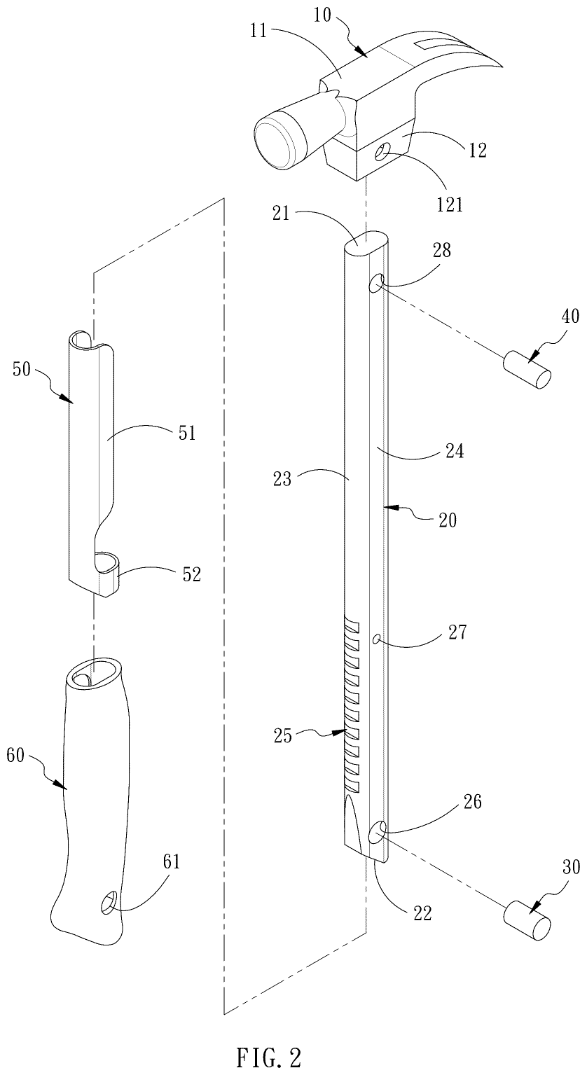

The strike member 10 has an operation part 11. Referring to FIG. 2, in the embodiment, the operation part 11 has a striking area used for hitting an object and a nail removing area used for removing a nail. However, the form of the strike member 10 is not limited as above-mentioned. For example, the operation part 11 is allowed to have both of its ends serving as striking area. The striking area is allowed to be formed to have a rounded surface as that of a conventional hammer (such as claw hammer, sledgehammer, and ball peen hammer) or formed in a blade shape similar to that of an ax.

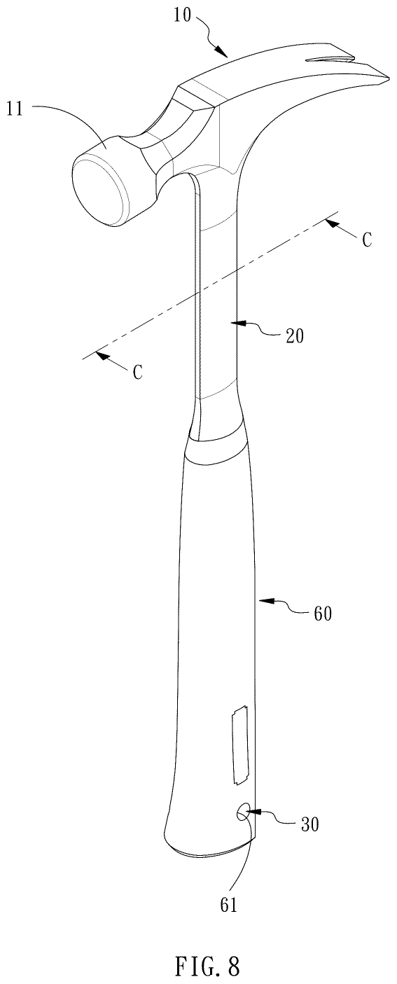

Referring to FIG. 1 to FIG. 3, in the embodiment, if the strike member 10 and the handle 20 are two components, the strike member 10 comprises a combination part 12 having a combination bore 121 passing therethrough, through which the strike member 10 and the handle 20 are connected. Referring to FIG. 8, in the embodiment, if the strike member 10 and the handle 20 are of one single component, the strike member 10 and the handle 20 are integrally formed.

The handle 20 is connected with the strike member 10. The handle 20 is formed in an approximate rectangular shape and has a first end 21 and an oppositely arranged second end 22, with two first sides 23 and two second sides 24 connected between the first end 21 and the second end 22. As shown in FIG. 2, when the strike member 10 and the handle 20 are two components, the combination part 12 of the strike member 10 is combined with the first end 21 of the handle 20. The first end 21 is formed in a flat shape. The width of each first side 23 is smaller than the width of each second side 24.

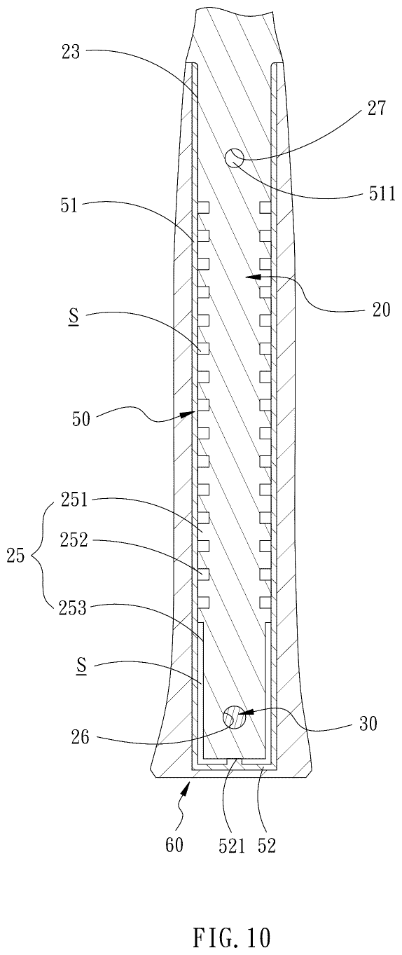

The handle 20 has a shock damping structure 25 arranged on one side thereof, such that the handle 20 has a non-smooth outer periphery. Therein, the shock damping structure 25 is allowed to be formed on either one of the first sides 23 or both of the two first sides 23. From the first embodiment to the fifth embodiment of the present application, the shock damping structure 25 is disposed on one of the first sides 23, as shown in FIG. 2 to FIG. 7 and FIG. 9. In the sixth embodiment of the present application, the shock damping structure 25 is disposed on both of the two first sides 23, as shown in FIG. 10.

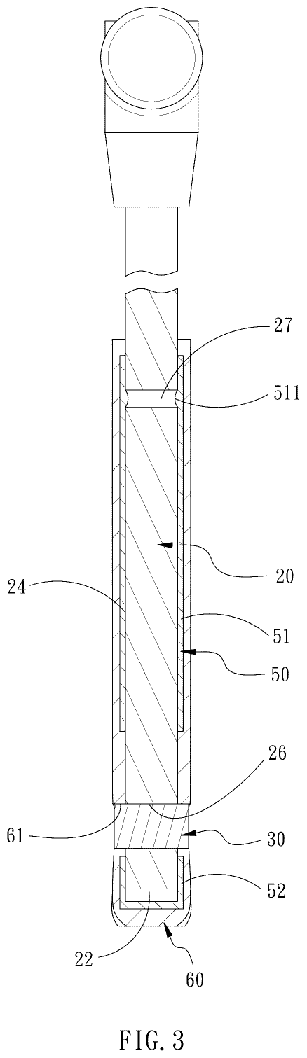

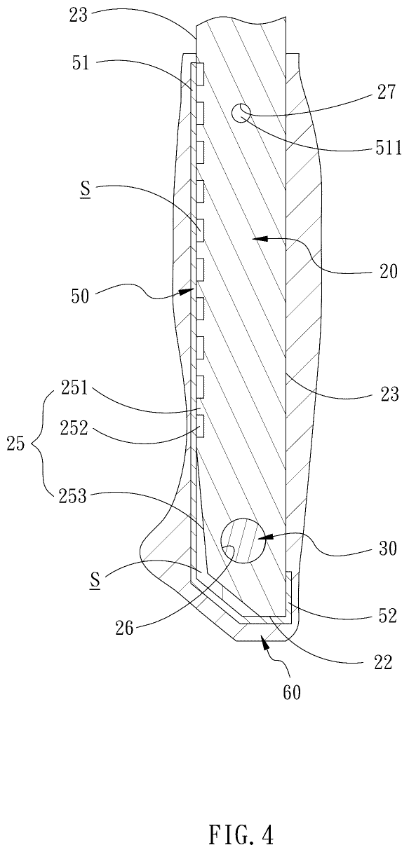

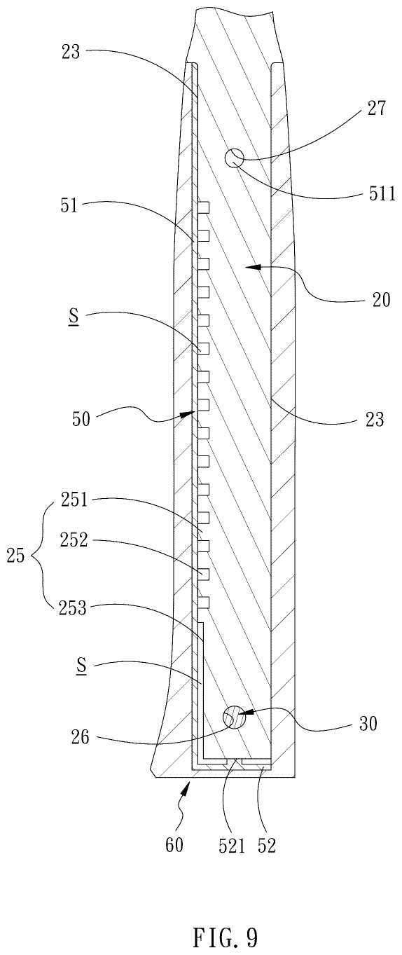

Also, the shock damping structure 25 and the handle 20 are integrally formed. The shock damping structure 25 comprises a plurality of convex parts 251, a plurality of concave parts 252, and a vacant part 253. The convex parts 251 and the concave parts 252 are disposed in a continuously alternating arrangement, and the vacant part 253 is connected with the concave part 252 neighboring the second end 22. Therein, the vacant part 253 is allowed to be formed from the first side 23 to the second end 22. The vacant part 253 has a turning corner, as shown by FIG. 3 to FIG. 10. Further, the vacant part 253 is allowed to be formed in an inclining shape (as shown by FIG. 4 to FIG. 7), L shape (as shown by FIG. 9), or U shape (as shown by FIG. 10).

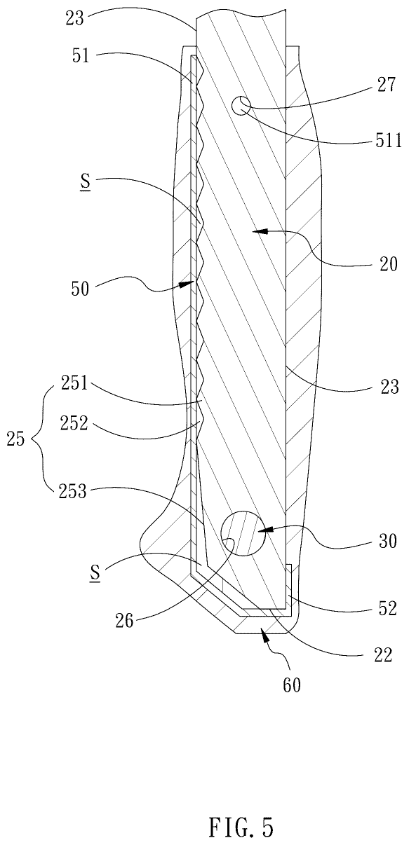

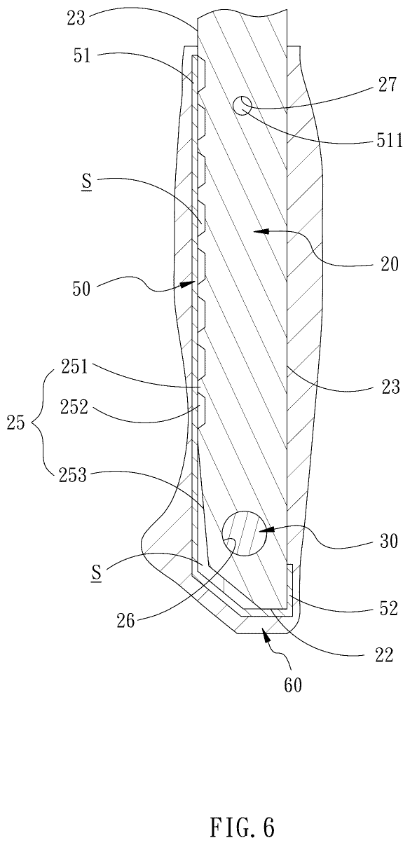

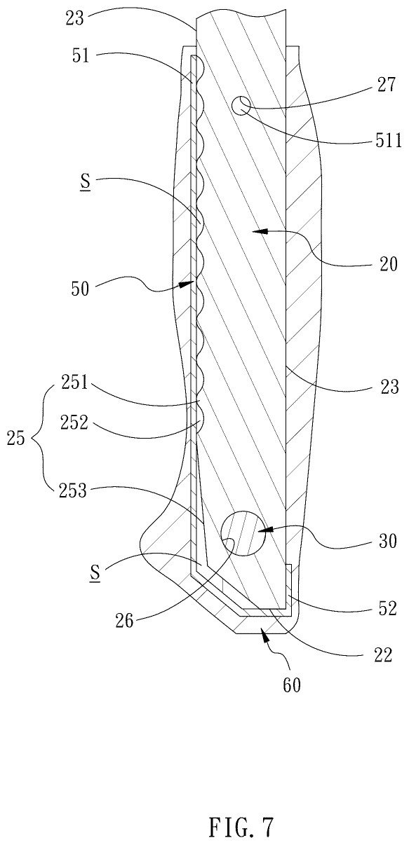

The length of the shock damping structure 25 is at least one-third of the length of the handle 20. The depth of each concave part 252 is at least one-tenth of the width of each second side 24. The cross-sectional face of each convex part 251 and each concave part 252 is allowed to be selected from rectangular, triangular, trapezoid, or arc shape. Referring to FIG. 2, FIG. 4, FIG. 9, and 10, in the first, fifth, and sixth embodiments of the present application, the cross-sectional face of each convex part 251 and each concave part 252 is formed in a rectangular shape. Referring to FIG. 5, in the second embodiment of the present application, the cross-sectional face of each convex part 251 and each concave part 252 is formed in a triangular shape. Referring to FIG. 6, in the third embodiment of the present application, the cross-sectional face of each convex part 251 and each concave part 252 is formed in a trapezoid shape. Referring to FIG. 7, in the fourth embodiment of the present application, the cross-sectional face of each convex part 251 and each concave part 252 is formed in an arc shape.

Also, the handle 20 has a first through hole 26 and a second through hole 27 passing therethrough. The first through hole 26 is arranged in adjacent to the second end 22, with a first pin 30 passing through the first through hole 26. The second through hole 27 is arranged on one side of the first through hole 26 toward the first end 21 and in adjacent to the shock damping structure 25. Therein, referring to FIG. 1 to FIG. 3, if the strike member 10 and the handle 20 are two components, the handle 20 has a third through hole 28 passing therethrough. The third through hole 28 is arranged on one side of the second through hole 27 away from the second end 22 and in adjacent to the first end 21. The combination bore 121 of the strike member 10 is in alignment with the third through hole 28 of the handle 20, with a second pin 40 passing through the combination bore 121 and the third through hole 28, such that the second pin 40 fixes the strike member 10 and the handle 20, as shown by FIG. 1 to FIG. 3.

The spacing member 50 is detachably connected with the handle 20. The spacing member 50 comprises a first portion 51 and a second portion 52, with a positioning block 511 protruding on one lateral side of the first portion 51, such that the positioning block 511 being engaged with the second through hole 27 of the handle 20. The second portion 52 of the spacing member 50 is mounted around the handle 20. In the embodiment, two positioning blocks 511 are included and symmetrically disposed on a lateral side of the first portion 51, respectively, as shown by FIG. 3.

Also, when the spacing member 50 is engaged with the handle 20, the first portion 51 of the spacing member 50 is in alignment with the shock damping structure 25, with a gap S formed between the spacing member 50 and the shock damping structure 25. The size of this gap S varies based on the distance between the concave parts 252 and the vacant part 253 with respect to the spacing member 50. The gap S serves as an air chamber and contains air therein, which is allowed to be ordinary or compressed air. The air in the gap S has a shock damping effect, and the damping force thereof is affected by the amount of air within the gap S. Notably, when the air in the gap S is compressed air, the air serves as an air spring which absorbs small and uncountable rebounding vibrations.

Referring to FIG. 9 to FIG. 10, in the fifth and sixth embodiments, when the vacant part 253 is formed in an L or U shape, the second portion 52 has a protruding abutting block 521 which abuts against the vacant part 253, such that the abutting block 521 is connected with the handle 20, whereby the handle 20 is stabilized and prevented from displacement during the striking operation.

The handle sleeve 60 is mounted around the handle 20 and the spacing member 50 from the second end 22 of the handle 20, and the handle sleeve 60 is fittingly attached to the spacing member 50. The handle sleeve 60 has an opening 61 passing therethrough. The handle sleeve 60 is connected with the handle 20. The opening 61 of the handle sleeve 60 is in alignment with the first through hole 26 of the handle 20, with the first pin 30 passing through the opening 61 and the first through hole 26, such that the first pin 30 fixes the handle sleeve 60 and the handle 20, as shown by FIG. 1 and FIG. 2.

Referring to the table below, it is shown that when two types of hammers are used to strike at approximately the same speed (around 32), the hammer equipped with the shock damping structure 25 of the present application exhibits a reduction in vibration amplitude of more than 5% compared to the hammer without the shock damping structure 25. Therefore, the present application actually demonstrates a damping effect.

| | | Acceleration (m/s) | | | | Shock |
|---|---|---|---|---|---|---|
| | Strike | X | Y | Z | | reduction |
| | speed | axis | axis | axis | Average | (%) |
| Claw hammer | | | | | | |
| With damping | 31.76 | 1025 | 301 | 984 | 770 | 5.325 |
| structure | | | | | | |
| No damping | 32.2 | 1049 | 408 | 976 | 811 | |
| structure | | | | | | |
| sledgehammer | | | | | | |
| With damping | 31.32 | 691 | 553 | 7576 | 607 | 5.107 |
| structure | | | | | | |
| No damping | 33.23 | 801 | 529 | 583 | 638 | |
| structure | | | | | | |

Thus, when the strike member 10 hits an object, the shock generated on the handle 20 is mitigated through the gap S formed between the shock damping structure 25 and the spacing member 50 based on the fact that the air within the gap S provides a cushioning effect, thereby reducing the impact of shock on the handle 20, effectively minimizing the vibration and achieving the damping effect.

Although particular embodiments of the application have been described in detail for purposes of illustration, various modifications and enhancements may be made without departing from the spirit and scope of the application. Accordingly, the application is not to be limited except as by the appended claims.

What is claimed is:

1. A hammering tool with damping structure, comprising:
a strike member;
a handle connected with the strike member, the handle comprising a shock damping structure disposed on one side thereof, such that the handle has a non-smooth outer periphery;
a spacing member detachably connected with the handle corresponding to the shock damping structure, with a gap formed between the spacing member and the shock damping structure; and
a handle sleeve mounted around the handle and the spacing member, the handle sleeve and the spacing member being fittingly attached.

2. The hammering tool with damping structure of claim 1, wherein the shock damping structure and the handle are integrally formed.

3. The hammering tool with damping structure of claim 2, wherein the handle is formed in an approximate rectangular shape; the handle has two first sides and two second sides; a width of each first side is smaller than a width of each second side; the shock damping structure is formed on either one of the first sides or both of the two first sides.

4. The hammering tool with damping structure of claim 3, wherein the shock damping structure comprises a plurality of convex parts and a plurality of concave parts disposed in a continuously alternating arrangement.

5. The hammering tool with damping structure of claim 4, wherein a depth of each concave part is at least one-tenth of the width of each second side.

6. The hammering tool with damping structure of claim 5, wherein each convex part and each concave part has a cross-sectional face formed in a shape selected from a group consisting of rectangular shape, triangular shape, trapezoid shape, and arc shape.

7. The hammering tool with damping structure of claim 5, wherein the shock damping structure has a length which is at least one-third of a length of the handle.

8. The hammering tool with damping structure of claim 4, wherein the spacing member comprises a first portion and a second portion; the first portion has a positioning block engaged with the handle; the second portion is mounted around the handle.

9. The hammering tool with damping structure of claim 8, wherein the shock damping structure comprises a vacant part connected with one of the concave parts.

10. The hammering tool with damping structure of claim 9, wherein the vacant part is formed in a shape selected from a group consisting of inclining shape, L shape, and U shape.

11. The hammering tool with damping structure of claim 9, wherein the second portion comprises a protruding abutting block which abuts against the vacant part.

12. The hammering tool with damping structure of claim 9, wherein the handle has a first end and an oppositely arranged second end; the strike member is connected with the first end of the handle; the handle sleeve is mounted from the second end of the handle.

13. The hammering tool with damping structure of claim 12, wherein the handle has a first through hole passing therethrough in adjacent to the second end, with a first pin passing through the handle sleeve and the first through hole of the handle.

14. The hammering tool with damping structure of claim 13, wherein the handle has a second through hole passing therethrough on one side of the first through hole toward the first end and arranged in adjacent to the shock damping structure; the positioning block of the spacing member is engaged with the second through hole.

15. The hammering tool with damping structure of claim 14, wherein the handle has a third through hole passing therethrough on one side of the second through hole away from the second end and arranged in adjacent to the first end, with a second pin passing through the strike member and the third through hole of the handle.

16. The hammering tool with damping structure of claim 14, wherein the strike member and the handle are integrally formed.
